(19) United States
(12) Patent Application Publication
(10) Pub. No.: US 2026/0368562 A1
(43) Pub. Date: Nov. 19, 2026

(54) PREDICTION METHOD, PREDICTION DEVICE, AND PREDICTION PROGRAM

(71) Applicant: Japan Organization for Metals and Energy Security, Tokyo (JP)

(72) Inventors: Taisuke Sakakibara, Tokyo (JP); Takeshi Shibuya, Tsukuba-shi, Ibaraki (JP); Seyong Park, Tsukuba-shi, Ibaraki (JP); Shun Ichige, Tsukuba-shi, Ibaraki (JP)

(21) Appl. No.: 19/745,173

(22) Filed: Jul. 17, 2026

Related U.S. Application Data
(63) Continuation of application No. PCT/JP2025/004209, filed on Feb. 7, 2025.

(30) Foreign Application Priority Data
Feb. 14, 2024 (JP) 2024-020044

(51) Int. Cl. G06N 5/04

(52) U.S. Cl. CPC G06N 5/04

(57) ABSTRACT

The present prediction method is a computer-implemented prediction method using feature data of a mineral particle, including: creating a prediction model by performing machine learning with the feature data as training data; and inputting the feature data to the prediction model and predicting a recovery probability of mineral particles in mineral processing on the basis of a value output from the prediction model, wherein the feature data of the mineral particle includes individual-particle feature data indicating features of the mineral particle, and particle-group feature data indicating features of a particle group composed of a plurality of the mineral particles.

### CROSS-REFERENCE TO RELATED APPLICATIONS

The present application is a continuation application of International Application number PCT/JP2025/004209, filed on Feb. 7, 2025, which claims priority under 35 U.S.C § 119 (a) to Japanese Patent Application No. 2024-020044, filed on Feb. 14, 2024, contents of which are incorporated herein by reference in their entirety.

### BACKGROUND OF THE INVENTION

The present disclosure relates to a prediction method, a prediction device, and a storage medium storing a prediction program for predicting a result of mineral processing.

### BACKGROUND OF THE INVENTION

Conventionally, mineral processing techniques for separating mined ore into valuable minerals and gangue minerals by a method such as flotation, gravity separation, magnetic separation, or the like have been known. Since only a small amount of ore samples for testing can be collected in the exploration stage, it is necessary to predict the recovery rate, grade, and the like of valuable minerals with a limited number of tests. Takeshi Shibuya, Shoki Kobayashi, Taisuke Sakakibara, Tatsuhiro Ono, and Kanehiko Kawasaki, “A Fundamental Study on Flotation Prediction Model using MLA Data based on Machine Learning,” Proceedings of the MMIJ Annual Meeting, Vol. 9 (2022), No. 2, The Mining and Materials Processing Institute of Japan, Sep. 7, 2022 discloses a method for predicting the recovery rate, grade, and the like of valuable minerals using a prediction model created by performing machine learning using, as training data, feature data for each particle in minerals identified by a Mineral Liberation Analyzer (MLA). Pereira L, Frenzel M, Khodadadzadeh M, Tolosana-Delgado R, Gutzmer J. “A self-adaptive particle-tracking method for minerals processing,” J Clean Prod 2021; 279:123711 also discloses a method for predicting the recovery rate, grade, and the like of valuable minerals using a machine-learned prediction model.

It is considered that the behavior of mineral particles is affected by other mineral particles in the vicinity thereof. Therefore, there has been a problem in that the recovery rate and grade obtained when the recovery probability of particles is predicted using a prediction model machine-learned using only feature data for each particle as training data deviate excessively from the actual recovery rate and grade.

The present disclosure has been made in view of these points, and its object is to provide a prediction method, a prediction device, and a storage medium storing a prediction program with improved prediction accuracy of the recovery probability of mineral particles in mineral processing.

A first aspect of the present disclosure provides a computer-implemented prediction method using feature data of a mineral particle, the prediction method including: creating a prediction model by performing machine learning with the feature data as training data; and inputting the feature data to the prediction model and predicting a recovery probability of mineral particles in mineral processing on the basis of a value output from the prediction model, wherein the feature data of the mineral particle includes: individual-particle feature data indicating features of the mineral particle; and particle-group feature data indicating features of a particle group composed of a plurality of the mineral particles.

A second aspect of the present disclosure provides a non-transitory storage medium storing a prediction program for causing a computer to execute, using feature data of a mineral particle: creating a prediction model by performing machine learning with the feature data as training data; and inputting the feature data to the prediction model and predicting a recovery probability of mineral particles in mineral processing on the basis of a value output from the prediction model, wherein the feature data of the mineral particle includes: individual-particle feature data indicating features of the mineral particles; and particle-group feature data indicating features of a particle group composed of a plurality of the mineral particles.

A third aspect of the present disclosure provides a prediction device including: a feature data acquisition unit that acquires feature data of a mineral particle; and a prediction unit that inputs the feature data to a prediction model created by performing machine learning with the feature data as training data, and predicts a recovery probability of mineral particles in mineral processing on the basis of a value output from the prediction model, wherein the feature data of the mineral particle may include: individual-particle feature data indicating features of the mineral particle; and particle-group feature data indicating features of a particle group composed of a plurality of the mineral particles.

### BRIEF DESCRIPTION OF THE DRAWINGS

FIG. 1 is a diagram for explaining an overview of a prediction system according to the present embodiment.

FIG. 2A is a diagram for explaining an overview of feature data.

FIG. 2B is a diagram for explaining an overview of feature data.

FIG. 3 is a diagram illustrating an example of training data.

FIG. 4 is a diagram showing an overview of prediction data used in predicting the recovery probability using a prediction model M.

FIG. 5 is a diagram illustrating a configuration of a prediction device 1.

FIG. 6 is a flowchart showing a training phase process in the prediction device 1.

FIG. 7 is a flowchart showing a prediction phase process in the prediction device 1.

FIG. 8 is a table showing a list of prediction models used in a comparative experiment.

FIG. 9 is a graph showing the copper recovery rate and copper grade obtained by flotation of particles ground for 15 minutes.

FIG. 10 is a graph showing prediction results of grades of a plurality of types of minerals obtained by flotation of particles ground for 15 minutes.

FIG. 11 is a graph showing the copper recovery rate and copper grade obtained by flotation of particles ground for 35 minutes.

FIG. 12 is a graph showing prediction results of grades of a plurality of types of minerals obtained by flotation of particles ground for 35 minutes.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### [Overview of Prediction System]

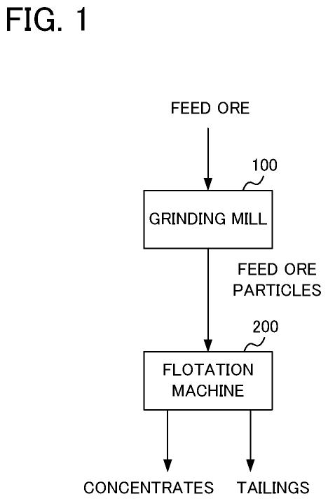

FIG. 1 is a diagram for explaining an overview of a prediction system according to the present embodiment. The prediction system is a system for predicting at least one of (i) the recovery probability of mineral particles in mineral processing, (ii) the recovery rate, and (iii) grade of the mineral particles obtained in mineral processing.

Mineral processing is separation of valuable minerals (concentrates) and gangue minerals (tailings) in ores, and includes a method such as flotation, gravity separation, magnetic separation, or the like. Valuable minerals are minerals corresponding to elements targeted for recovery. Although the present disclosure can be applied to any mineral processing method, the present specification mainly describes, as an example, a case where the mineral processing method is flotation.

Flotation is one of the ore-separation methods most widely used in the mineral processing industry, and is a method for separating valuable mineral particles and gangue mineral particles based on difference in hydrophobicity of ore surfaces. For example, as shown in FIG. 1, feed ore before separation is introduced into a grinding mill 100 and ground, and feed ore particles after grinding are introduced into a flotation machine 200. Specifically, finely ground ore particles are introduced together with a frother into the flotation machine 200 containing a medium such as water, and hydrophobic valuable mineral particles are attached to bubbles generated by stirring, whereby the valuable mineral particles are floated and recovered. Minerals (mineral particles) floated as a result of flotation are referred to as concentrates, and minerals (mineral particles) precipitated are referred to as tailings.

Depending on the mines, the recovery rate of concentrates from mined ore and the grade represented by the mass fraction of target elements contained in the recovered concentrates differ. In order to increase the economic profitability of mining, it is necessary to improve the recovery rate and grade. In flotation, there are operating variables such as grinding time, flotation time, and pH, and the recovery rate and grade can be improved by determining operating variables that lead to optimal grade and recovery rate.

Conventionally, these operating variables are determined by repeatedly performing flotation tests and modifying the operating variables according to empirical rules. When operating variables are determined on the basis of empirical rules, setting of the operating variable values, confirmation of test results associated therewith (that is, the grade and recovery rate of target elements), and resetting of the operating variable values are repeatedly performed, resulting in significant costs in terms of both time and money.

Therefore, in recent years, studies have been conducted to reduce the number of tests for determining operating variables by using a machine learning-based prediction model for determining the operating variables. Machine learning is a computational technique using past information such as experience and data in order to improve accuracy in a given prediction task, and in recent years, prediction models for predicting results of flotation tests using machine learning have been developed.

Conventional prediction models output a recovery probability of a particle when feature data indicating feature quantities of the particle is input. When the mineral processing method is flotation, the recovery probability is a probability that a mineral particle floats (i.e., a probability that the mineral particle becomes a concentrate). Conventional prediction models are created on an assumption that interactions occurring between particles do not affect the recovery probability.

However, it is considered that interactions between particles in flotation greatly affect mineral processing results. Therefore, in a prediction method according to the present embodiment, prediction accuracy of the recovery probability is improved by executing processing in consideration of effects of interactions between particles in flotation. Specifically, in the prediction method according to the present embodiment, when creating a prediction model, in addition to feature data of an individual mineral particle, feature data indicating feature quantities of a particle group including the mineral particle is also used as training data. When predicting the recovery probability using the prediction model, in addition to feature data of an individual mineral particle, feature data indicating feature quantities of a particle group including the mineral particle is input to the prediction model. The prediction model is created by machine learning selected from, for example, random forest, neural network, logistic regression analysis, and the like.

### [Overview of Feature Data]

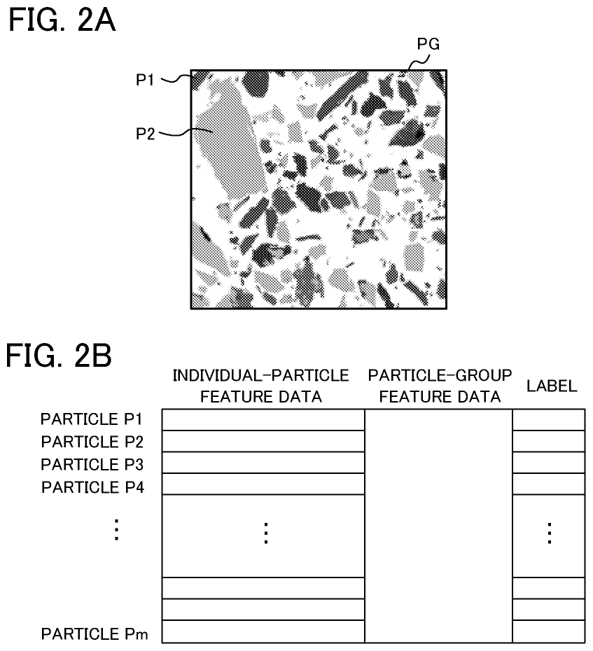

FIGS. 2A and 2B are each a diagram for explaining an overview of feature data. FIG. 2A is an image of a cross section of a mineral, which is a target for generating feature data, captured with an electron microscope. Each of the regions having various shapes shown in the image shown in FIG. 2A corresponds to a mineral particle (e.g., a particle P1, a particle P2). A plurality of particles included in a region enclosed by a quadrilateral outer periphery of FIG. 2A constitute a particle group PG.

FIG. 2B is a diagram illustrating an overview of training data for creating a prediction model. The training data illustrated in FIG. 2B corresponds to the particle group PG illustrated in FIG. 2A, and is configured by feature data of each particle from the particle P1 to a particle Pm (m is an integer) included in the particle group PG.

The training data illustrated in FIG. 2B includes, for each of a plurality of particles P included in the particle group PG, individual-particle feature data indicating feature quantities of a single particle P and a label indicating whether the particle P is a concentrate or a tailing, and further includes particle-group feature data indicating feature quantities of the particle group PG. Because concentrates and tailings include many particle groups PG, a plurality of pieces of training data corresponding to the plurality of particle groups PG are used as training data. Accordingly, many combinations of the individual-particle feature data, particle-group feature data, and the label are used as training data.

As the feature data, for example, MLA data indicating a plurality of features of the particles identified by the Mineral Liberation Analyzer is used, but the feature data may be generated by other means without using the MLA data. When generating the training data, first, random sampling is performed from a plurality of pieces of MLA data corresponding to the plurality of particles such that a particle number ratio between concentrates and tailings becomes 1:1. Next, bootstrapping is performed a plurality of times on the plurality of randomly sampled particles to generate a plurality of data sets, and individual-particle feature data of each of the plurality of particles included in each of the plurality of data sets obtained by bootstrapping is identified. Next, by calculating feature quantities of a particle group including each of the plurality of particles, particle-group feature data corresponding to each of the plurality of particles is generated. Then, the training data is generated by assigning a label indicating whether each of the plurality of particles is a concentrate or a tailing to a set of the individual-particle feature data and the particle-group feature data corresponding to each of the plurality of particles.

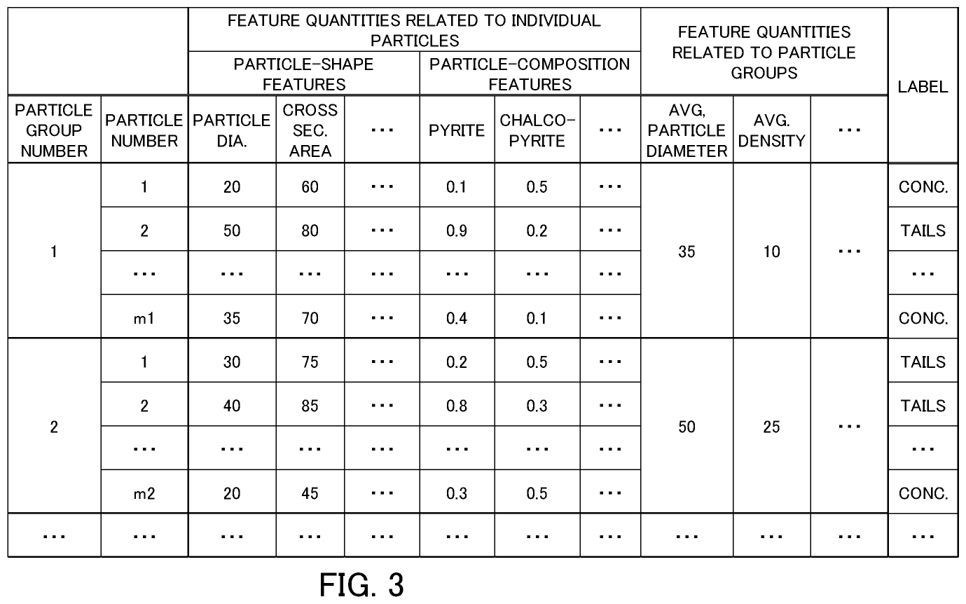

FIG. 3 is a diagram illustrating an example of training data. In the training data shown in FIG. 3, a combination of a particle group number and a particle number, feature quantities related to individual particles, feature quantities related to particle groups, and a label are associated with each other. The feature quantities related to individual particles include feature quantities related to particle shapes and feature quantities related to particle compositions. The feature quantities related to particle shapes of individual particles are, for example, a particle diameter and a cross-sectional area of the particle. The feature quantities related to particle compositions are content ratios of minerals such as pyrite and chalcopyrite. As the feature quantities related to individual particles, for example, feature quantities corresponding to 20 types of features are used, and as the feature quantities related to particle compositions, feature quantities corresponding to, for example, 90 types of features, which are greater in number than the feature quantities related to individual particles, are used. Note that the number of feature quantities may be any number, and a part of the feature quantities may be selected from a plurality of usable feature quantities so that the number of feature quantities is reduced.

The feature quantities related to particle groups are values indicating group features having a high relevance to an inter-particle interaction, such as an average value of diameters of a plurality of particles included in the particle group or a density of the plurality of particles included in the particle group. The label is a value indicating whether the particle is a concentrate or a tailing.

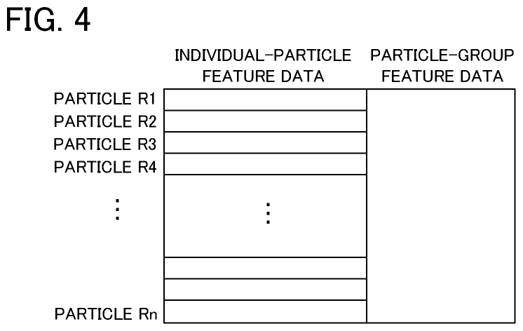

FIG. 4 is a diagram illustrating an overview of prediction data used in predicting the recovery probability using a prediction model M. The prediction data is data in which the individual-particle feature data and the particle-group feature data are associated with each other, but is different from the training data shown in FIG. 2B in that it does not include a label. The prediction data is generated on the basis of, for example, MLA data of feed ore. Since the prediction data shown in FIG. 4 is constituted by feature data corresponding to particles different from those corresponding to the feature data included in the training data, the particle names in FIG. 4 are RI to Rn (n is an integer). When such prediction data is input to the prediction model, the prediction model outputs the recovery probability.

In general, the amount of tailings is larger than that of concentrates, and a ratio at which feed ore is distributed to concentrates differs depending on implementation conditions defined by mineral processing conditions (e.g., flotation conditions), specifications of an apparatus used for mineral processing (e.g., the flotation machine 200), a feature quantity distribution of feed ore, and the like. Therefore, when the training data is generated by performing the bootstrapping for sampling MLA data such that a particle-number ratio between concentrates and tailings becomes 1:1, as described above, an error may occur between the recovery probability output by the prediction model and an actual recovery probability under the implementation conditions.

Therefore, in the prediction method according to the present embodiment, a prior probability indicating a ratio between concentrates and tailings corresponding to conditions under which mineral processing is performed is identified in advance, and the recovery probability output by the prediction model is corrected using the prior probability corresponding to the conditions for performing mineral processing. Accordingly, it is possible to predict the recovery probability with high accuracy for each implementation condition. Details of correction processing based on the prior probability will be described later.

### [Configuration of Prediction Device 1]

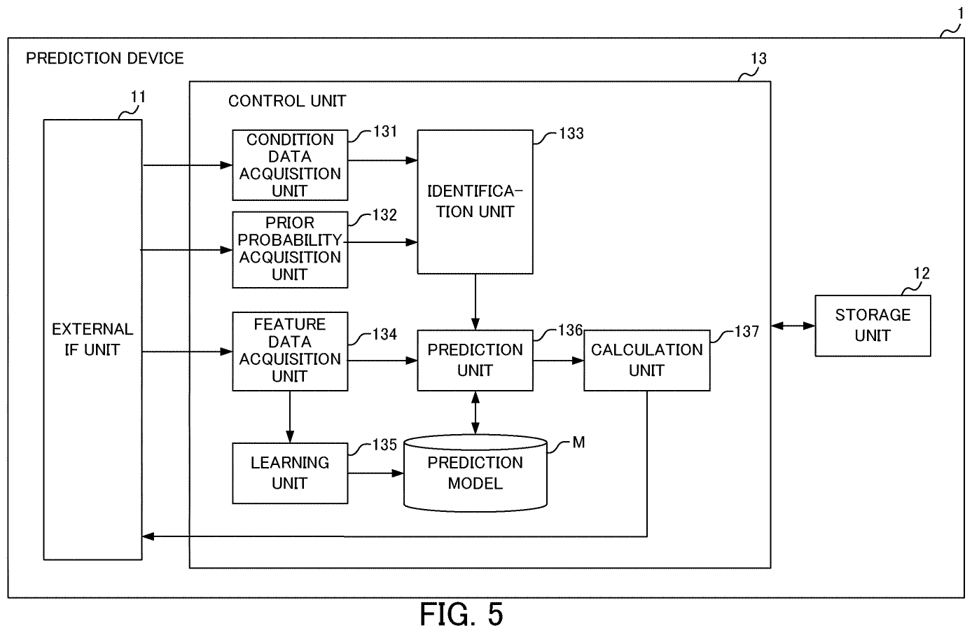

FIG. 5 is a diagram illustrating a configuration of a prediction device 1. The prediction device 1 includes an external IF unit 11, a storage unit 12, and a control unit 13. The control unit 13 is, for example, a central processing unit (CPU), and functions as a condition data acquisition unit 131, a prior probability data acquisition unit 132, an identification unit 133, a feature data acquisition unit 134, a learning unit 135, a prediction unit 136, and a calculation unit 137 by executing programs stored in the storage unit 12. The control unit 13 also functions as the prediction model M by executing the programs stored in the storage unit 12. The prediction model M may be provided outside the control unit 13 (for example, in another computer).

The external IF unit 11 includes at least one of a user interface such as a keyboard and a mouse for a user of the prediction device 1 to input data, a display for displaying data, and a communication interface for transmitting and receiving data to and from an external device. The prediction device 1 acquires data from the user or the external device via the external IF unit 11, and outputs results of calculating the recovery probability of concentrate particles, and the recovery rate and grade of concentrates.

The storage unit 12 includes a storage medium such as a read only memory (ROM), a random access memory (RAM), and a solid state drive (SSD). The storage unit 12 stores programs executed by the control unit 13. The storage unit 12 stores various types of data used by the control unit 13 to calculate the recovery probability and the recovery rate and grade. The storage unit 12 may store weights of a neural network included in the prediction model M.

The condition data acquisition unit 131 acquires condition data indicating conditions for performing mineral processing. The condition data includes, for example, operating variables at the time of performing mineral processing, a model name of the flotation machine 200, a feature quantity distribution of feed ore, or the like. The condition data acquisition unit 131 acquires the condition data by, for example, displaying a screen for inputting the condition data on the display. The condition data acquisition unit 131 may acquire, from the external device, condition data input by the user into the external device. The condition data acquisition unit 131 acquires, for example, first condition data indicating a condition for performing mineral processing and second condition data indicating a condition under which training data is obtained. The condition data acquisition unit 131 inputs the acquired condition data to the identification unit 133.

The condition data acquisition unit 131 may acquire data indicating a target element subjected to mineral processing. The data indicating the target element is, for example, text data indicating an element such as Cu or Fe. The condition data acquisition unit 131 inputs the data indicating the target element to the feature data acquisition unit 134. The data indicating the target element may be stored in the storage unit 12 in advance.

The prior probability data acquisition unit 132 acquires prior probability data indicating a prior probability that is a ratio of concentrates or a ratio of tailings corresponding to each of a plurality of conditions for performing mineral processing. That is, the prior probability data acquisition unit 132 acquires a plurality of pieces of prior probability data associated with each condition.

Similarly to the condition data acquisition unit 131, the prior probability data acquisition unit 132 may acquire the prior probability data by displaying a screen for inputting the prior probability data on the display, or may acquire, from the external device, the prior probability data input by the user into the external device. The prior probability data acquisition unit 132 inputs the acquired prior probability data to the identification unit 133. The prior probability data acquisition unit 132 may input the prior probability data to the identification unit 133 by storing the acquired prior probability data in the storage unit 12.

The identification unit 133 identifies an optimal prior probability corresponding to prior probability data corresponding to the condition closest to the condition indicated by the first condition data among the plurality of pieces of prior probability data input from the prior probability data acquisition unit 132. For example, the identification unit 133 selects the prior probability data corresponding to the condition closest to the condition under which mineral processing indicated by the first condition data is performed, on the basis of distances between (i) a plurality of vectors each composed of a plurality of elements representing a condition corresponding to respective prior probability data and (ii) a vector composed of a plurality of elements representing the condition for performing mineral processing. That is, the identification unit 133 sets, as the optimal prior probability, a prior probability indicated by the prior probability data corresponding to the vector closest to the vector composed of the plurality of elements representing the condition indicated by the first condition data. The identification unit 133 notifies the prediction unit 136 of the identified optimal prior probability.

Note that the plurality of vectors each composed of a plurality of elements representing a condition corresponding to respective prior probability data are also referred to as executed mineral-processing condition data, and correspond to the second condition data. The vector composed of a plurality of elements representing a condition for performing mineral processing is also referred to as unexecuted mineral-processing condition data, and corresponds to the first condition data.

### [Training Phase]

Next, processing in a training phase for creating the prediction model M will be described. The feature data acquisition unit 134 acquires training individual-particle feature data indicating features of a mineral particle and training particle-group feature data indicating features of a particle group.

Specifically, the feature data acquisition unit 134 acquires first training individual-particle feature data indicating features of a training particle contained in concentrates. The feature data acquisition unit 134 acquires second training individual-particle feature data indicating features of a training particle contained in tailings. The feature data acquisition unit 134 acquires first training particle-group feature data indicating features of a training particle group contained in concentrates and composed of a plurality of training particles including the training particle. The feature data acquisition unit 134 acquires second training particle-group feature data indicating features of a training particle group contained in tailings and composed of a plurality of training particles including the training particle.

The feature data acquisition unit 134 generates first training data in which a label indicating a concentrate is assigned to a set of the first training individual-particle feature data and the first training particle-group feature data, and inputs the first training data to the learning unit 135. In addition, the feature data acquisition unit 134 inputs, to the learning unit 135, second training data in which a label indicating a tailing is assigned to a set of the second training individual-particle feature data and the second training particle-group feature data.

In order to create a plurality of prediction models M corresponding to a plurality of conditions under which mineral processing may be performed, the feature data acquisition unit 134 may acquire training individual-particle feature data and training particle-group feature data in association with the conditions. That is, in the step of acquiring the first training individual-particle feature data, the feature data acquisition unit 134 may acquire a plurality of pieces of first training individual-particle feature data corresponding to each of a plurality of conditions for performing mineral processing. In the step of acquiring the second training individual-particle feature data, the feature data acquisition unit 134 may acquire a plurality of pieces of second training individual-particle feature data corresponding to each of a plurality of conditions for performing mineral processing.

In the step of acquiring the first training particle-group feature data, the feature data acquisition unit 134 may acquire a plurality of pieces of first training particle-group feature data corresponding to each of the plurality of conditions for performing mineral processing. In the step of acquiring the second training particle-group feature data, the feature data acquisition unit 134 may acquire a plurality of pieces of second training particle-group feature data corresponding to each of the plurality of conditions for performing mineral processing. The feature data acquisition unit 134 generates, for each condition, the first training data and the second training data, and inputs the generated first and second training data to the learning unit 135.

The learning unit 135 creates the prediction model M by performing machine learning using the first training data in which the label indicating a concentrate is assigned to the set of the first training individual-particle feature data and the first training particle-group feature data, and the second training data in which the label indicating a tailing is assigned to the set of the second training individual-particle feature data and the second training particle-group feature data. The learning unit 135 creates the prediction model M by inputting the first training data or the second training data to the prediction model M and updating the weights of the neural network included in the prediction model M.

The learning unit 135 may create, for each condition for performing mineral processing, a prediction model corresponding to each of a plurality of conditions by performing machine learning using (i) first training data in which a label indicating a concentrate is assigned to a set of the first training individual-particle feature data and the first training particle-group feature data, and (ii) second training data in which a label indicating a tailing is assigned to a set of the second training individual-particle feature data and the second training particle-group feature data. In this case, the learning unit 135 causes the storage unit 12 to store the weights of the neural network included in the plurality of prediction models M respectively corresponding to different conditions for performing mineral processing, for example, in association with the respective conditions.

### [Prediction Phase]

After the training phase, processing in a prediction phase is executed. In the prediction phase, the prediction unit 136 predicts recovery probabilities of mineral particles contained in target ore (feed ore) to be subjected to mineral processing, and the calculation unit 137 outputs information indicating the recovery rate and grade of the mineral particles obtained by the mineral processing. The recovery probabilities of the mineral particles to be subjected to mineral processing are assumed to be unknown.

In the prediction phase, the feature data acquisition unit 134 acquires individual-particle feature data indicating features of the mineral particles to be subjected to mineral processing. In addition, the feature data acquisition unit 134 acquires particle-group feature data indicating features of a particle group composed of a plurality of particles contained in the feed ore. The feature data acquisition unit 134 notifies the prediction unit 136 of the acquired individual-particle feature data and particle-group feature data.

The prediction unit 136 predicts a recovery probability for each of the plurality of particles contained in the feed ore. The recovery probability for each mineral particle is predicted on the basis of a value output by the prediction model M in response to inputting the individual-particle feature data and the particle-group feature data to the prediction model M created by performing machine learning using, as training data, a set of the training individual-particle feature data and the training particle-group feature data to which a label indicating a concentrate or a tailing is assigned. The prediction unit 136 predicts the recovery probability for each particle by inputting, for each type of particle, the individual-particle feature data and particle-group feature data corresponding to the particle to the prediction model M.

For example, the prediction unit 136 may input, to the prediction model M, a subset of the feature quantities selected by dimension reduction from a plurality of feature quantities included in the individual-particle feature data acquired by the feature data acquisition unit 134 and a subset of the feature quantities selected by dimension reduction from of a plurality of feature quantities included in the particle-group feature data acquired by the feature data acquisition unit 134.

As described above, when the training individual-particle feature data and the training particle-group feature data in which the ratio between concentrates and tailings is 1:1 are used when creating the prediction model M, a recovery probability higher than the recovery probability under conditions for actually performing mineral processing is output from the prediction model M.

Therefore, in the step of predicting the recovery probability, the prediction unit 136 predicts the recovery probability of each mineral particle by correcting the value output by the prediction model M with the optimal prior probability calculated by the identification unit 133. Specifically, the prediction unit 136 corrects a recovery probability of each target particle by multiplying the recovery probability of one particle output from the prediction model M by a value obtained by dividing the optimal prior probability by a ratio of the number of particles labeled as concentrates in the training data, and performing normalization. The prediction unit 136 inputs the corrected recovery probability of each mineral particle to the calculation unit 137.

Note that the prediction unit 136 may predict the recovery probability using the prediction model M corresponding to a condition indicated by the first condition data. For example, the prediction unit 136 selects a prediction model M for which the similarity between (i) a condition indicated by the second condition data corresponding to the training individual-particle feature data and the training particle-group feature data used by each of the plurality of prediction models M for training and (ii) the condition indicated by the first condition data is greatest, and inputs the individual-particle feature data and the particle-group feature data to the selected prediction model M, thereby increasing the recovery probability output by the prediction model M.

The calculation unit 137 calculates, on the basis of the recovery probability of each particle notified by the prediction unit 136, the recovery rate of an element for which the recovery rate is to be calculated and the grade, in a concentrate, of an element for which the grade is to be calculated. Specifically, the calculation unit 137 calculates the recovery rate of an element for which the recovery rate by mineral processing is to be calculated by dividing (i) a sum obtained by multiplying the recovery probability of each particle predicted by the prediction unit 136, the mass of each particle obtained by analysis using the MLA, and the grade, in each particle, of the element for which the recovery rate is to be calculated and then adding together the resulting products, by (ii) a sum obtained by multiplying the mass of each particle obtained by analysis using the MLA and the grade, in each particle, of the element for which the recovery rate is to be calculated and then adding together the resulting products.

More specifically, the calculation unit 137 calculates a recovery rate R by the following expression using the mass of Xⱼ and the grade in wt % of the target element in Xⱼ when the number of particles of the target element for which the recovery probability is predicted by the prediction unit 136 is m and the recovery probability after correction for the j-th particle Xⱼ is y (Xⱼ). The target element in the following description is an element whose recovery rate is to be calculated.

$$R = \frac{\begin{matrix}{\sum }_{j = 1}^{m} y ( {X}_{j} ) ( mass of {X}_{j} \times \\ grade of target element in {X}_{j} ( wt \% ) )\end{matrix}}{\begin{matrix}{\sum }_{j = 1}^{m} ( mass of {X}_{j} \times \\ grade of target element in {X}_{j} ( wt \% ) )\end{matrix}} \qquad [ Formula 1 ]$$

In addition, in order to calculate the grade indicating a proportion of the target element in concentrates obtained by mineral processing, the calculation unit 137 first multiplies the recovery probability of each of a plurality of target particles predicted by the prediction unit 136 by the mass of each of the plurality of target particles, and then adds together the resulting products. Then, the calculation unit 137 calculates the grade indicating the proportion of the target element in concentrates obtained by mineral processing, on the basis of a ratio, to the above-added value, of a value obtained by multiplying (i) the recovery probability of each of the plurality of target particles, (ii) the mass of each of the plurality of target particles, and (iii) a mass percentage of the target particles contained in feed ore, and then adding together the resulting products.

Specifically, when the mass of Xⱼ is MXⱼ and the mass % of the target element is wt, the calculation unit 137 calculates a grade Q by the following expression.

$$Q = \frac{{\sum }_{j = 1}^{m} y ( {X}_{j} ) \times ( {MX}_{j} \times wt )}{{\sum }_{j = 1}^{m} y ( {X}_{j} ) \times {MX}_{j}} \qquad [ Formula 2 ]$$

The calculation unit 137 outputs a value indicating the calculated recovery rate and grade through the external IF unit 11. The calculation unit 137 may cause the display to display the value indicating the recovery rate and grade, or may transmit the value to an external computer.

### [Process in Prediction Device 1]

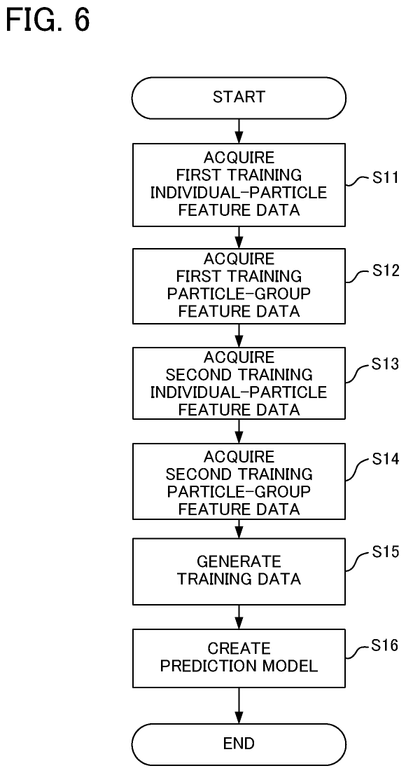

FIG. 6 is a flowchart showing a training phase process in the prediction device 1. The feature data acquisition unit 134 acquires first training individual-particle feature data corresponding to concentrates (S11). The feature data acquisition unit 134 acquires first training particle-group feature data corresponding to concentrates (S12). The feature data acquisition unit 134 acquires second training individual-particle feature data corresponding to tailings (S13). The feature data acquisition unit 134 acquires second training particle-group feature data corresponding to tailings (S14). The order of the processes from S11 to S14 is arbitrary.

The feature data acquisition unit 134 generates first training data by assigning a label indicating a concentrate to the first training individual-particle feature data and the first training particle-group feature data, and generates second training data by assigning a label indicating a tailing to the second training individual-particle feature data and the second training particle-group feature data (S15). The learning unit 135 creates a prediction model M using the generated first training data and second training data (S16).

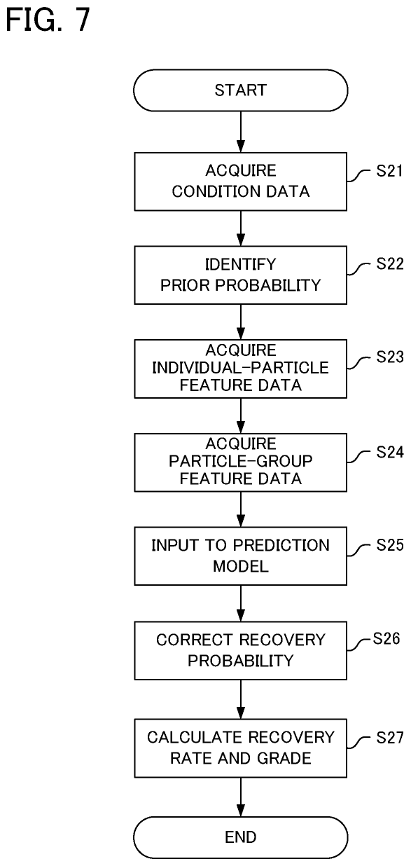

FIG. 7 is a flowchart showing a prediction phase process in the prediction device 1. The condition data acquisition unit 131 acquires first condition data indicating a condition for performing mineral processing on minerals containing mineral particles of a target element whose recovery rate and grade are to be predicted (S21). The identification unit 133 identifies a prior probability corresponding to the first condition data acquired by the condition data acquisition unit 131 (S22), and notifies the prediction unit 136 of the identified prior probability.

The feature data acquisition unit 134 acquires individual-particle feature data of each of the mineral particles of the target element whose recovery rate and grade are to be predicted (S23). In addition, the feature data acquisition unit 134 acquires particle-group feature data corresponding to the particle (S24). The feature data acquisition unit 134 inputs the individual-particle feature data and the particle-group feature data to the prediction model M (S25). The feature data acquisition unit 134 sequentially inputs the individual-particle feature data and the particle-group feature data corresponding to each of the plurality of particles to the prediction model M.

Next, the prediction unit 136 corrects the recovery probability corresponding to each of the plurality of mineral particles output by the prediction model M on the basis of the prior probability notified from the identification unit 133 (S26). The calculation unit 137 calculates the recovery rate and grade of the mineral particles corresponding to the target element on the basis of the corrected recovery probability for each of the mineral particles (S27). Note that the processes from S23 to S25 may be performed before the processes from S21 to S22 are performed.

### Experimental Results

### [Collection of Ore Samples]

From copper ore mined from a mine, twelve samples of 1 kg each were collected. Implementation conditions other than the grinding time were the same, and four copper ore samples were assigned to each of three grinding time conditions (15 minutes, 25 minutes, and 35 minutes). From concentrates and tailings, 12 resin-embedded samples (3 from concentrates and 9 from tailings) were prepared and subjected to MLA analysis. The MLA analysis mode was set to XBSE, and data for 50,000 particles or more were acquired for each sample.

### [Creation of Prediction Model]

In order to confirm the effectiveness of the prediction method according to the present embodiment, a plurality of types of prediction models corresponding to conventional prediction methods and a prediction model corresponding to the prediction method according to the present embodiment were created. From MLA data of concentrates and tailings, 80,000 particles (40,000 from concentrates and 40,000 from tailings) were randomly sampled. The collected MLA data included 108 features, and in order to remove correlations among the features as much as possible and shorten the training time, 10 features were selected using a minimum redundancy maximum relevance algorithm (MRMR algorithm). D50, D80, a diameter standard deviation, an average density, a density standard deviation, an average copper mass fraction, an average iron mass fraction, and an average sulfur mass fraction were used as training particle-group feature data for creating the prediction model corresponding to the prediction method according to the present embodiment.

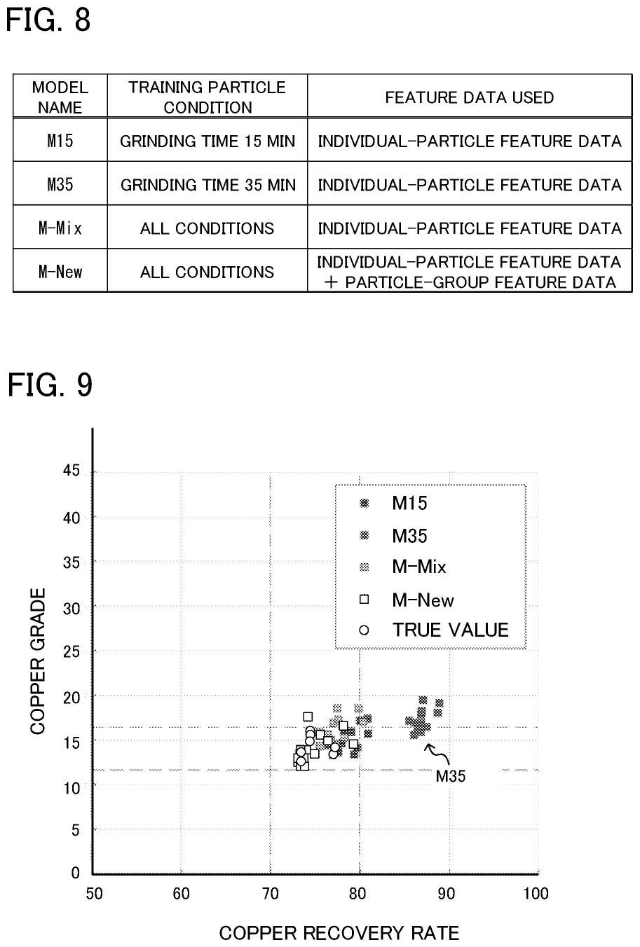

FIG. 8 is a table showing a list of prediction models used in a comparative experiment. The model M15 is a prediction model created using, as training data, individual-particle feature data of particles obtained by grinding minerals for 15 minutes. The model M35 is a prediction model created using, as training data, individual-particle feature data of particles obtained by grinding minerals for 35 minutes. The model M-Mix is a prediction model created using, as training data, individual-particle feature data of a plurality of particles obtained by grinding minerals for each of 15 minutes, 25 minutes, and 35 minutes.

The model M-New is the prediction model M according to the present embodiment, which is created using training data including particle-group feature data together with the individual-particle feature data of a plurality of particles obtained by grinding minerals for each of 15 minutes, 25 minutes, and 35 minutes.

### [Comparison Results]

FIG. 9 is a graph showing the copper recovery rate and copper grade obtained by flotation of mineral particles ground for 15 minutes. Circles in FIG. 9 indicate true values representing actually measured recovery rates and grades. Hollow squares in FIG. 9 represent recovery rates and grades calculated using the prediction model M-New according to the present embodiment. The recovery rates and grades are calculated by correcting values output by the prediction model M using prior probabilities (for example, optimal prior probabilities). Since the grinding time of the particles to be predicted is 15 minutes, the recovery rates and grades obtained when the prediction model M35 is used deviate significantly from the true values. The recovery rates and grades obtained when the prediction models M15 and M-Mix are used are closer to the true values than those obtained when the prediction model M35 is used, whereas those obtained when the prediction model M-New is used are even closer to the true values. In this manner, the effectiveness of predicting recovery probabilities using particle-group feature data was confirmed.

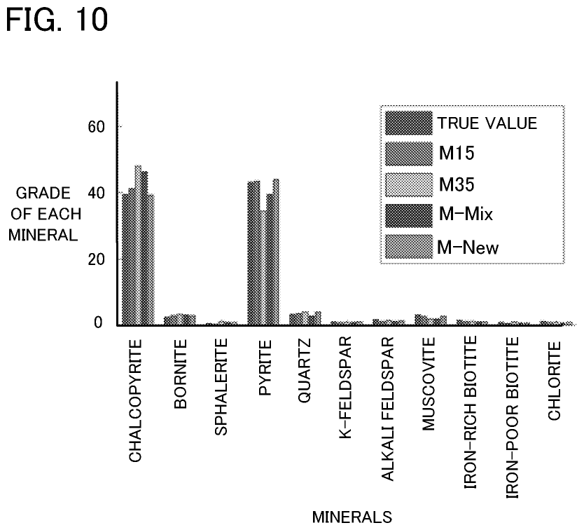

FIG. 10 is a graph showing prediction results of grades of a plurality of types of minerals obtained by flotation of particles ground for 15 minutes. For each mineral, the value at the left end is the true value, and the value at the right end is the grade value predicted using the prediction model M-New. With reference to the results of chalcopyrite and pyrite, the predicted grade values obtained using the prediction model M-New are approximately equal to the corresponding true values, and from this point as well, the effectiveness of predicting recovery probabilities using particle-group feature data was confirmed.

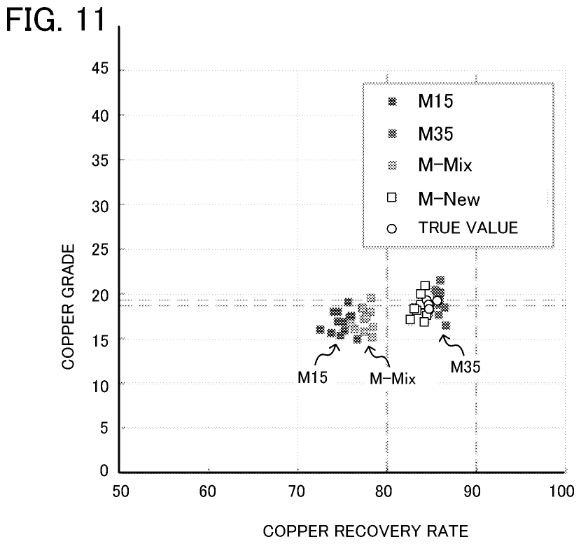

FIG. 11 is a graph showing the copper recovery rate and copper grade obtained by flotation of particles ground for 35 minutes. Circles in FIG. 11 indicate the true values representing actually measured recovery rates and grades. Hollow squares in FIG. 11 represent the recovery rates and grades calculated using the prediction model M-New according to the present embodiment. Since the grinding time of the particles to be predicted is 35 minutes, the recovery rates and grades obtained when the prediction model M15 is used deviate significantly from the true values. The recovery rates and grades obtained when the prediction models M35 and M-Mix are used are closer to the true values than those obtained using the model M15, whereas those obtained using the model M-New are even closer to the true values. The effectiveness of predicting recovery probabilities using particle-group feature data was confirmed from this example as well.

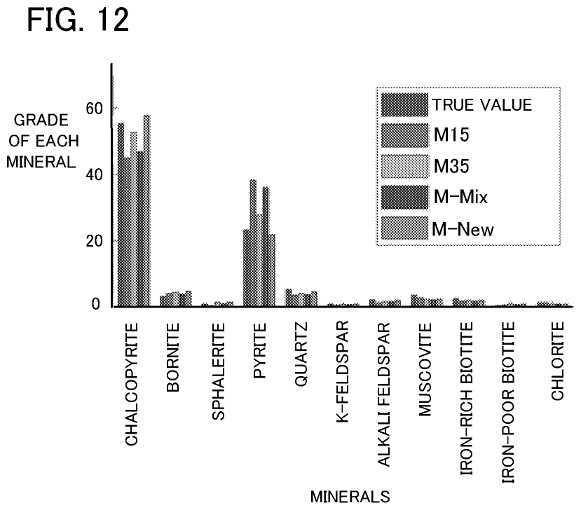

FIG. 12 is a graph showing prediction results of grades of a plurality of types of minerals obtained by flotation of particles ground for 35 minutes. For each mineral, the value at the left end is the true value, and the value at the right end is the grade value predicted using the prediction model M-New. With reference to the results for chalcopyrite and pyrite, the predicted grade values obtained using the prediction model M-New are approximately equal to the corresponding true values, and from this point as well, the effectiveness of predicting recovery probability using particle-group feature data was confirmed.

### Effect of Prediction Method According to Present Embodiment

As described above, in the prediction method according to the present embodiment, a computer predicts the recovery probability of particles on the basis of the value output by the prediction model in response to inputting the individual-particle feature data and the particle-group feature data to the prediction model created by performing machine learning using, as training data, a set of the training individual-particle feature data and the training particle-group feature data to which a label indicating a concentrate or a tailing is assigned. By predicting the recovery probabilities of the particles using the particle-group feature data in this manner, the accuracy of predicting the recovery rate and grade of the mineral particles obtained in mineral processing is improved.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

For example, although the prediction device 1 creates the prediction model M and predicts the recovery rate and grade of a target mineral in the above description, the prediction device 1 does not need to include the learning unit 135 and may use a prediction model M created in advance. Furthermore, in training data, the ratio of the first training data corresponding to concentrates and the second training data corresponding to tailings is 1:1, but this ratio is arbitrary as well.

In the above description, a case where MLA data is used to generate the individual-particle feature data and the particle-group feature data is exemplified, but other data may be used. In particular, a particle size distribution analyzer may be used to generate particle-group feature data.

What is claimed is:

1. A computer-implemented prediction method using feature data of a mineral particle, the prediction method comprising:
creating a prediction model by performing machine learning with the feature data as training data; and
inputting the feature data to the prediction model and predicting a recovery probability of mineral particles in mineral processing on the basis of a value output from the prediction model, wherein the feature data of the mineral particle includes:
individual-particle feature data indicating features of the mineral particle; and
particle-group feature data indicating features of a particle group composed of a plurality of the mineral particles.

2. The prediction method according to claim 1, wherein the individual-particle feature data and the particle-group feature data used as the training data in the creating the prediction model include individual-particle feature data and particle-group feature data of mineral particles in recovered concentrates and tailings.

3. The prediction method according to claim 1, wherein the individual-particle feature data and the particle-group feature data used in the predicting the recovery probability of the mineral particles include individual-particle feature data and particle-group feature data of mineral particles whose recovery probabilities are unknown.

4. The prediction method according to claim 1, further comprising:
acquiring first condition data indicating a condition for performing mineral processing;
acquiring second condition data indicating a condition under which the training data is obtained;
acquiring prior probability data indicating a prior probability that is a ratio of the number of concentrate particles to the number of feed ore particles or a ratio of the number of tailings particles to the number of feed ore particles, corresponding to each of a plurality of conditions for performing mineral processing; and
identifying, in the prior probability data, an optimal prior probability corresponding to a condition closest to a condition indicated by the first condition data among a plurality of conditions indicated by the second condition data, wherein the predicting the recovery probability includes predicting the recovery probability by correcting a value output by the prediction model with the optimal prior probability.

5. The prediction method according to claim 1, further comprising:
creating the prediction model by the machine learning selected from any one of random forest, neural network, and logistic regression analysis.

6. The prediction method according to claim 1, wherein the predicting the recovery probability includes inputting, to the prediction model, a subset of feature quantities selected by dimension reduction from a plurality of feature quantities included in the acquired individual-particle feature data and a subset of feature quantities selected by dimension reduction from a plurality of feature quantities included in the acquired particle-group feature data.

7. A non-transitory storage medium storing a prediction program for causing a computer to execute, using feature data of a mineral particle:
creating a prediction model by performing machine learning with the feature data as training data; and
inputting the feature data to the prediction model and predicting a recovery probability of mineral particles in mineral processing on the basis of a value output from the prediction model, wherein the feature data of the mineral particle includes:
individual-particle feature data indicating features of the mineral particles; and
particle-group feature data indicating features of a particle group composed of a plurality of the mineral particles.

8. A prediction device comprising:
a feature data acquisition unit that acquires feature data of a mineral particle; and
a prediction unit that inputs the feature data to a prediction model created by performing machine learning with the feature data as training data, and predicts a recovery probability of mineral particles in mineral processing on the basis of a value output from the prediction model, wherein the feature data of the mineral particle includes:
individual-particle feature data indicating features of the mineral particle; and
particle-group feature data indicating features of a particle group composed of a plurality of the mineral particles.
